(19) United States
(12) Patent Application Publication
(10) Pub. No.: US 2005/0169247 A1
(43) Pub. Date: Aug. 4, 2005

(54) LAN-TO-LAN VOIP SYSTEM AND RELATED USER INTERFACE

(76) Inventor: Heng-Chien Chen, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,045

(22) Filed: Feb. 4, 2004

(51) Int. Cl. H04L 12/66

(52) U.S. Cl. 370/352

(57) ABSTRACT

A LAN-to-LAN VoIP system and related user interface. The VoIP system comprises a first LAN and a second LAN. The first LAN comprises a first local telephone system, a first communication module, a first IP-based extension, and a first host. The second LAN comprises a second local telephone system, a second communication module, a second IP-based extension, and a second host. Each communication module connects each local telephone systems to the Internet through a respective dynamic IP address, each IP-based extension is connected to the Internet through another dynamic IP address, and each host is connected to the Internet through a respective static IP address. Each IP-based extension can dial to the local telephone system directly in the same LAN or dial to the host followed by the local telephone systems across LAN. The user interface, used in each IP-based extension, comprises a first functional key for dialing to the trunk lines of the first local telephone system and a second functional key for dialing to the trunk lines of the second local telephone system.

### BACKGROUND OF INVENTION

1. Field of the Invention

The present invention relates to a Voice over Internet Protocol (VoIP) system and related user interface, and more particularly, to a LAN-to-LAN VoIP system with the related user interface which connects local area networks (LAN) to one another.

2. Description of the Prior Art

With the popularity of Internet connections, VoIP systems are developed to transmit voice efficiently over the Internet. Please refer to FIG. 1. FIG. 1 is a functional block diagram of a VoIP system 10 according to the prior art. The VoIP system 10 connects a plurality of voice gateways 14, and 16 through respective Internet connections 12.

The Internet connections 12 may be xDSL connections or other broadband Internet connections, which provide static IP addresses to the voice gateways 14 and 16. The voice gateways 14 are electrically connected to a private branch exchange (PBX) 22 and a normal telephone 24 with FXS interface, while the voice gateway 16 is electrically connected to a public switched telephone network (PSTN) 26 with FXO interface. The PBX 22 provides telephone service to a plurality of normal telephones 24.

The voice gateways 14 and 16 convert voice signals into voice packets for transmitting the voice packets via the Internet 20, and convert voice packets received through the Internet 20 into voice signals for transmitting the voice signals to the PBX 22, normal telephone 24, and the PSTN 26. However, each of the PBX 22, normal telephone 24, and the PSTN 26 require static IP addresses for Internet connections in the VoIP system 10. Not only are the static IP addresses expensive, but also a static IP address is needed in the VoIP system 10 for each normal telephone or PSTN.

### SUMMARY OF INVENTION

It is therefore a primary objective of the claimed invention to provide a LAN-to-LAN VoIP system and the related user interface to solve the above-mentioned problem.

According to the claimed invention, a VoIP system comprises a first LAN and a second LAN. The first LAN comprises a first local telephone system, a first communication module, a first IP-based extension, and a first host. The second LAN comprises a second local telephone system, a second communication module, a second IP-based extension, and a second host. Each communication module connects each local telephone system to the Internet through a respective dynamic IP address, each communication module connects to the corresponding local telephone system through a trunk line, each IP-based extension is connected to the Internet through another dynamic IP address, and each host is connected to the Internet through a respective static IP address. Each IP-based extension can dial to the local telephone system directly in the same LAN or dial to the host followed by the local telephone systems across LAN. The user interface, used in each IP-based extension, comprises a first functional key for dialing to the trunk line of the first local telephone system and a second functional key for dialing to the trunk line of the second local telephone system.

It is an advantage of the claimed invention that the LAN-to-LAN VoIP system and related user interface can connect a plurality of LANs to one another. In each LAN, the IP-based extensions can access the trunk lines, and dial to the PBX as well as the normal telephones in an extension-like way in the same LAN. Additionally, if the IP-based extension in one LAN dials to the IP-based extensions, the normal telephones, or PSTN in another LAN, the voice packets transmitted from the IP-based extension are transmitted to the NPBX host at first. Only the hosts of each LAN need static IP addresses such that the static IP addresses are mostly reduced in the LAN-to-LAN VoIP system. In addition, the functional keys, used in the IP-based extension for connecting to the trunk lines directly, provide users with a more friendly user interface.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a functional block diagram of a VoIP system according to the prior art.

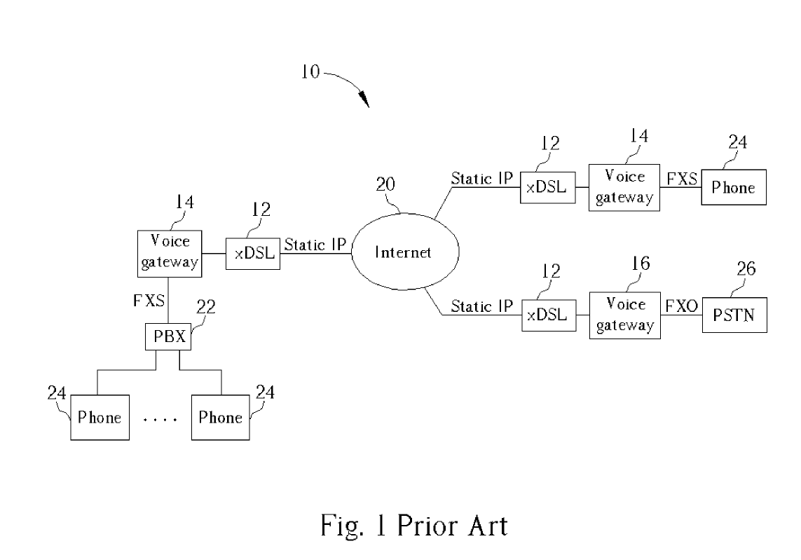

FIG. 2 is a functional block diagram of a LAN-to-LAN VoIP system according to a first embodiment of the present invention.

FIG. 3 is a functional block diagram of a LAN-to-LAN VoIP system according to a second embodiment of the present invention.

FIG. 4 is a diagram of the related user interface in the LAN-to-LAN VoIP system according to the present invention.

### DETAILED DESCRIPTION

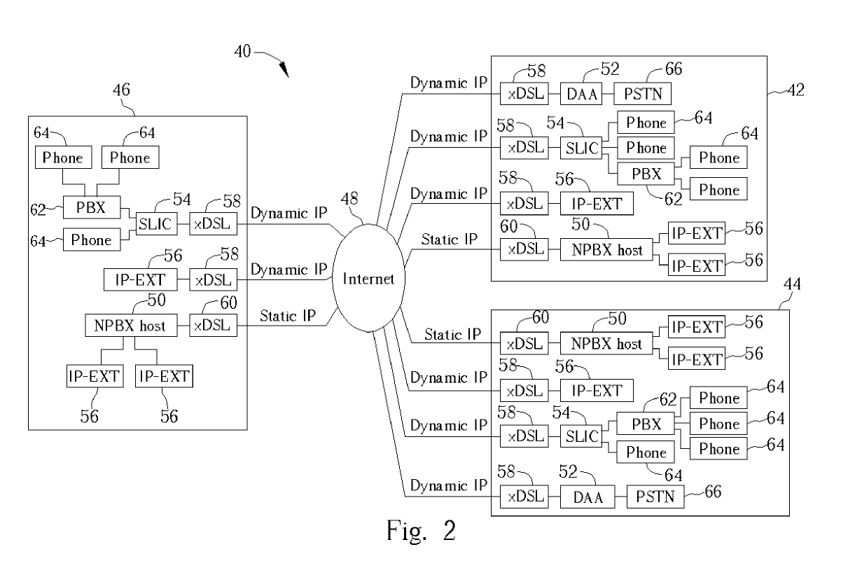

Please refer to FIG. 2. FIG. 2 is a functional block diagram of a LAN-to-LAN VoIP system 40 according to a first embodiment of the present invention. The LAN-to-LAN VoIP system connects a plurality of LANs 42, 44, and 46 via the Internet 48. Each of the LANs 42, 44, and 46 has a respective network private branch exchange (NPBX) host 50 connected to the Internet 48 through a respective Internet connection 60. The Internet connection 60 may be an xDSL connection or other broadband Internet connection, which provides a static IP address to the NPBX host 50.

Additionally, each of the LANs 42, 44, and 46 comprises a plurality of communication modules, which connect a plurality of local telephone systems to the Internet 48 through a plurality of Internet connections 58. The Internet connection 58 may be an xDSL connection or other broadband Internet connections, which provide dynamic IP addresses to the communication modules.

The communication modules are data access arrangement (DAA) modules 52 or subscriber line interface circuit (SLIC) modules 54, which converts voice signals received from the local telephone systems to voice packets for transmission over the Internet 48, and restores voice packets received through the Internet 48 into voice signals. The local telephone systems comprise a private branch exchange (PBX) 62, a normal telephone 64, or a public switched telephone network (PSTN) 66. The PBX 62 provides telephone service to a plurality of normal telephone 64. Besides, each LAN comprises a plurality of IP-based extensions 56, which are connected to the NPBX host 50 directly or to the Internet 48 through the Internet connections 58.

As shown in each LAN of the FIG. 2, a PSTN 66 is connected to the Internet 48 through a DAA module 52, a PBX 62 and a plurality of normal telephones 64 are connected to the Internet 48 through a SLIC module 54, and a plurality of IP-based extensions 56 are connected to the NPBX host 50 and the Internet 48. In each LAN, the IP-based extensions 56 can access the trunk lines of the DAA module 52 to dial to the PSTN 66, and dial to the PBX 62 as well as the normal telephones 64 in an extension-like way in the same LAN. Additionally, if the IP-based extension 56 in one LAN dials to the IP-based extensions 56, the normal telephones 64, or PSTN 66 in another LAN, the voice packets transmitted from the IP-based extension 56 are transmitted to the NPBX host at first. For example, the voice packets transmitted to the IP-based extensions 56, the normal telephones 64, or PSTN 66 of the LAN 42 are transmitted to the NPBX host 50 of the LAN 42 through the static IP address. In the following, the NPBX host 50 controls and transmits the voice packets to the IP-based extensions 56, the normal telephones 64, or PSTN 66 in the LAN 42 through the dynamic IP addresses.

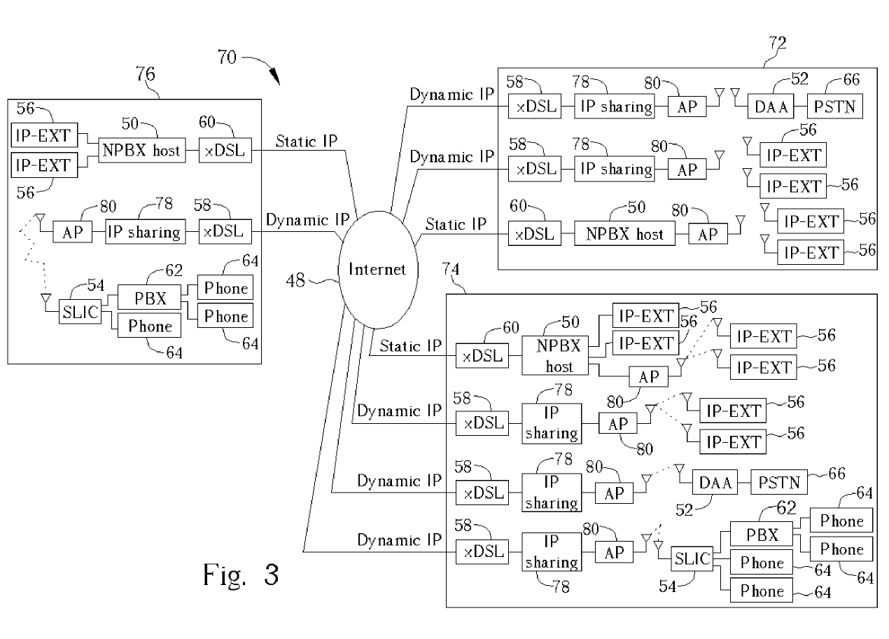

All connections between the DAA modules 52, the SLIC modules 54, the IP-based extensions 56, and the Internet 48 are wired connections in FIG. 2. Please refer to FIG. 3. FIG. 3 is a functional block diagram of a LAN-to-LAN VoIP system 70 according to a second embodiment of the present invention. The LAN-to-LAN VoIP system 70 is similar to the LAN-to-LAN VoIP system 40, and the same reference numbers will be used to refer to the same parts. Instead of using wired connections to connect local telephone systems, the LAN-to-LAN VoIP system 70 utilizes IP sharing 78 and access points 80 to wirelessly connect the DAA modules 52, the SLIC modules 54, the IP-based extensions 56, and the Internet 48. As shown, the DAA modules 52, SLIC modules 54, and the IP-based extensions 56 can all communicate with the access point 80 to connect the Internet 48 using at least one of the many IEEE 802.11x protocols. Besides, the IP-based extensions 56 can communicate with the access point 80 to connect the NPBX 50 using at least one of the many IEEE 802.11x protocols.

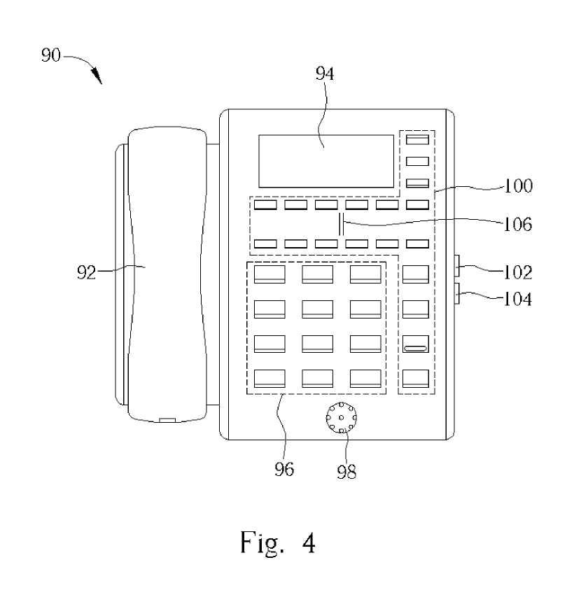

Please refer to FIG. 4. FIG. 4 is a diagram of the related user interface 90 in the LAN-to-LAN VoIP system 40 according to the present invention. The user interface 90 is used in the IP-based extensions 56. The user interface comprises a handset 92 to receive voice signals from users, a display screen 94 to show information of the calls, a plurality of numeral keys 96 to dial, a microphone 98 to receive calls from users, a plurality of functional keys 100, a wired network interface 102 complying with the IEEE 802.3 protocol, and a wireless network interface 104 complying with the IEEE 802.11 protocol. The functional keys 100 comprise a plurality of LED 106 to assist display, showing the incoming or reserving calls. The wired network interface 102 has an RJ12 female connector, and the wireless network interface 104 is a PCMCIA slot or USB connector.

The functional keys 100 operate the functions of redialing, reserving, volume adjusting, broadcasting, controlling the display screen, and so forth. The functional keys 100 are further set to connect the trunk lines of the DAA modules 52 of each LAN, which makes the IP-based extensions 56 can quickly access the trunks lines and real-time display usage status of trunk lines. The NPBX host 50 of each LAN numbers the trunk lines of each LAN serially whether the DAA modules 52 are locate on. The serial number of the trunk lines provides users to know usage status of each trunk line, which can be real-time displayed on the display screen 94. In addition, the functional keys 100 of the IP-extensions in one LAN are further set to connect to the IP extensions of the other LANs. That is, all of the IP extensions can be viewed as the extension-like telephones in the LAN-to-LAN VoIP system 40 and 100. The NPBX hosts 50 coordinate the connections between the LAN 42, 44, and 46, which makes users easily access all of the trunk lines and the IP extensions across the LANs.

In contrast to the prior art, the present invention LAN-to-LAN VoIP system and related user interface can connect a plurality of LANs to one another. In each LAN, the IP-based extensions can access the trunk lines, and dial to the PBX as well as the normal telephones in an extension-like way in the same LAN. Additionally, if the IP-based extension in one LAN dials to the IP-based extensions, the normal telephones, or PSTN in another LAN, the voice packets transmitted from the IP-based extension are transmitted to the NPBX host at first. Only the hosts of each LAN need static IP addresses such that the static IP addresses are mostly reduced in the LAN-to-LAN VoIP system. The IP extensions are further viewed as the extension-like telephones in the LAN-to-LAN VoIP system, which reduces requirement of the extensions in the LAN-to-LAN VoIP system and increases convenience to carry the IP extensions. In addition, the functional keys, used in the IP-based extension for connecting to the trunk lines and the IP extensions directly, provide users with a more friendly user interface.

Those skilled in the art will readily observe that numerous modifications and alterations of the device may be made while retaining the teachings of the invention. Accordingly, that above disclosure should be construed as limited only by the metes and bounds of the appended claims.

1. A voice over internet protocol (VoIP) system and related user interface, comprising:
a first local area network (LAN), comprising:
a first local telephone system;
a first communication module for connecting the first local telephone system to the Internet through a first dynamic IP address, the first communication module connecting to the first local telephone system through a first trunk line, the first communication module capable of converting voice signals received from the first local telephone system to voice packets for transmission over the Internet and capable of restoring voice packets received through the Internet into voice signals;
a first IP-based extension connected to the Internet through a second dynamic IP address, the first IP-based extension can dial to the first local telephone system directly; and
a first host connected to the Internet through a first static IP address, the first host controlling voice packet transmission of the first telephone system via the Internet;
a second LAN, comprising:
a second local telephone system;
a second communication module for connecting to the second local telephone system to the Internet through a third dynamic IP address, the second communication module connecting to the second local telephone system through a second trunk line, the second communication module capable of converting voice signals received from the second local telephone system to voice packets for transmission over the Internet and capable of restoring voice packets received through the Internet into voice signals;
a second IP-based extension connected to the Internet through a fourth dynamic IP address, the second IP-based extension can dial to the second local telephone system directly; and
a second host connected to the Internet through a second static IP address, the second host controlling voice packet transmission of the second local telephone system via the Internet; and
a user interface, used in each of the first and second IP-based extensions, the user interface comprising:
a first functional key for dialing to the trunk lines of the first local telephone system; and
a second functional key for dialing to the trunk lines of the second local telephone system.

2. The VoIP system and related user interface of claim 1 wherein the first local telephone system is selected from the group consisting of a public switched telephone network (PSTN), a private branch exchange (PBX), and a normal telephone.

3. The VoIP system and related user interface of claim 1 wherein the second local telephone system is selected from the group consisting of a PSTN, a PBX, and a normal telephone.

4. The VoIP system and related user interface of claim 1 wherein the first communication module is selected from the group consisting of a data access arrangement (DAA) module and a subscriber line interface circuit (SLIC) module.

5. The VoIP system and related user interface of claim 1 wherein the second communication module is selected from the group consisting of a DAA module and a SLIC module.

6. The VoIP system and related user interface of claim 1 wherein the first and second communication modules are each connected to the Internet through a network cable according to the IEEE 802.3 protocol.

7. The VoIP system and related user interface of claim 1 wherein the first and second communication modules are each wirelessly connected to the Internet through an access point, and the first and second communication modules wirelessly communicate with the respective access points according to an IEEE 802.11x protocol.

8. The VoIP system and related user interface of claim 1 wherein the first and second IP-based extensions are each connected to the Internet through a network cable according to the IEEE 802.3 protocol.

9. The VoIP system and related user interface of claim 1 wherein the first and second IP-based extensions are each wirelessly connected to the Internet through an access point, and the first and second IP-based extensions wirelessly communicate with the respective access points according to an IEEE 802.11x protocol.

10. The VoIP system and related user interface of claim 1 wherein the user interface of the first IP extension of the first LAN further comprises a third functional key for dialing to the second IP extension of the second LAN.

11. The VoIP system and related user interface of claim 1 wherein the user interface of the second IP extension of the second LAN further comprises a third functional key for dialing to the first IP extension of the first LAN.
